(19) United States
(12) Patent Application Publication
(10) Pub. No.: US 2003/0169288 A1
(43) Pub. Date: Sep. 11, 2003

(54) Representative image generating apparatus

(76) Inventor: Takeshi Misawa, Asaka-shi (JP)

Correspondence Address: BIRCH STEWART KOLASCH & BIRCH, PO BOX 747, FALLS CHURCH, VA, 22040-0747, US

(21) Appl. No.: 10/384,660

(22) Filed: Mar. 11, 2003

(30) Foreign Application Priority Data
Mar. 11, 2002 (JP) 2002-064723
Feb. 10, 2003 (JP) 2003-031858

(51) Int. Cl. G09G 5/00

(52) U.S. Cl. 345/719

(57) ABSTRACT

Playback time (display time) of an image represented by an image file contained in a folder is measured image by image, and folder icons (representative images) are generated using the images having the longest playback times. Since folder icons are created using images that the user considers important, merely observing a folder icon makes it possible for the user to grasp the content of images of a plurality of frames represented by the image files contained in the folder identified by this folder icon.

### BACKGROUND OF THE INVENTION

1. Field of the Invention

This invention relates to an apparatus for generating data that representing a representative image that stands for a plurality of frames of images represented by image files contained in a folder.

2. Description of the Related Art

Figures referred to as icons are displayed on the display screen of a display unit, which has been connected to a personal computer, in order to identify software and files, etc., that have been stored on a hard disk of the personal computer. In the case of a folder containing image files, the icon of the folder is displayed. Clicking on the folder icon opens the folder and displays the icons of the image files contained in the folder. Clicking on the icon of a displayed image file opens the image file identified by the icon of the image file clicked. The image represented by the opened image file is displayed.

By assigning a folder name that suitably represents a plurality of frames of images represented by image files stored in the folder, it is possible to predict, more or less, the types of images represented by the image files contained in the folder. Assigning a suitable folder name, however, is not always easy.

Further, there are instances where the image represented by the initial image file of file names among the contained image files is adopted as the representative image of the folder. However, such a representative image does not necessarily coincide with the representative image the user has in mind.

### SUMMARY OF THE INVENTION

Accordingly, an object of the present invention is to generate a representative image that the user has in mind.

According to the first invention, the foregoing object is attained by providing an apparatus for generating a folder icon, comprising a playback-time measurement device (playback-time measurement means) for measuring playback times of a plurality of frames of images represented by image files contained in a folder; and a representative image data generating device (representative image data generating means) for generating representative image data, which stands for the plurality of frames of images represented by the image files contained in the folder, based upon an image file that corresponds to the longest playback time among the playback times of the plurality of frames of images measured by the playback-time measurement device.

The present invention may be adapted so as to provide a control method suited to the above-described folder icon generating apparatus. Specifically, the method comprises the steps of measuring playback times of a plurality of frames of images represented by image files contained in a folder; and generating representative image data, which stands for the plurality of frames of images represented by the image files contained in the folder, based upon an image file that corresponds to the longest playback time among the playback times of the plurality of frames of images measured.

A program for implementing the above method and a recording medium on which the program has been stored may also be provided.

In accordance with the first invention, the playback times of a plurality of frames of images represented by image files contained in a folder are measured. Representative image data is generated based upon an image file that corresponds to the longest playback time among the playback times of the plurality of frames of images measured (namely an image file representing the image having the longest playback time). The longer the playback time of an image, the longer that particular image has been enjoyed by the user. Since the image most frequently enjoyed by the user is thus adopted as the representative image, an image that the user construes to be important becomes the representative image.

The representative image data may be folder icon data that identifies a folder. Since the representative image is thus utilized as the folder icon, merely glancing at the folder icon enables one to ascertain the content of the images represented by the image files contained in the folder identified by the folder icon.

Preferably, the playback time measurement device measures playback time of an image in a case where the image is being displayed when a display device, which displays the representative image generated by representative image data generating device, is in the active state.

When the user does not perform any operation for a fixed period of time, the display device shifts to a standby mode or displays a screensaver image. This means that even if an image is being generated, the image is not actually being observed. Since playback time is measured when the display device is active (i.e., when an image is being displayed), it is possible to measure the time the user has spent essentially enjoying the image.

The apparatus may further comprise a display control device (display controller) for controlling the display device so as to display a representative image (folder icon) on the display screen.

The apparatus may further comprise a sorting device (sorting means) for sorting playback times of a plurality of frames of images, which have been measured by the playback measurement device, in order of decreasing time. In this case, processing for generating the folder icon data based upon an image file corresponding to the longest playback time would be executed whenever sorting is performed by the sorting device.

As a result, the folder icon can be displayed promptly.

An apparatus for generating a folder icon (a representative image) according to the second invention comprises a counting device (counting means) for counting numbers-of-times of playback (numbers of playback times) for a plurality of frames of images represented by image files contained in a folder, and a representative image data generating device (representative image data generating means) for generating representative image data, which stands for the plurality of frames of images represented by the image files contained in the folder, based upon an image file that corresponds to the largest number-of-times of playback among the numbers-of-times of playback of the plurality of frames of images counted by the counting device.

The present invention may be adapted so as to provide a control method suited to the above-described folder icon generating apparatus. Specifically, the method comprises the steps of counting numbers-of-times of playback for a plurality of frames of images represented by image files contained in a folder; and generating representative image data, which stands for the plurality of frames of images represented by the image files contained in the folder, based upon an image file that corresponds to the largest number-of-times of playback among the numbers-of-times of playback the plurality of frames of images counted.

A program for implementing the above method and a recording medium on which the program has been stored may also be provided.

In accordance with the second invention, the numbers-of-times of playback for a plurality of frames of images represented by image files contained in a folder are counted. Representative image data is generated based upon an image file that corresponds to the largest number-of-times of playback among the numbers-of-times of playback of the plurality of frames of images counted (namely an image file representing the image having the largest number-of-times of playback). The larger the number-of-times of playback of an image, the longer that particular image has been enjoyed by the user. Since the image most frequently enjoyed by the user is thus adopted as the representative image, an image that the user construes to be important becomes the representative image.

The apparatus may further comprise a playback-time measurement device (playback-time measurement means) for measuring playback time of the frame of the image represented by the image file contained in the folder.

In this case the counting device counts or increment the number of times of playback (number of playback times) by one when the playback time measured by the playback-time measurement device exceeds predetermined time.

The playback time becomes longer with regard to the image which a user consider to be important. Since the number of playback times is incremented for the image having the longer playback time, the really important image becomes the representative image.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a computer system;

FIGS. 2 to 5 are flowcharts illustrating a folder display processing;

FIG. 6 illustrates the content of playback-time file;

FIGS. 7 to 9 illustrate examples of windows displayed on a display screen;

FIGS. 10 and 11 illustrate examples of display screens;

FIG. 12 is a flowchart illustrating processing for measuring playback time; and

FIG. 13 is a flowchart illustrating processing for counting a number of playback times.

### DESCRIPTION OF THE PREFERRED EMBODIMENT

A preferred embodiment of the present invention will now be described in detail with reference to the drawings.

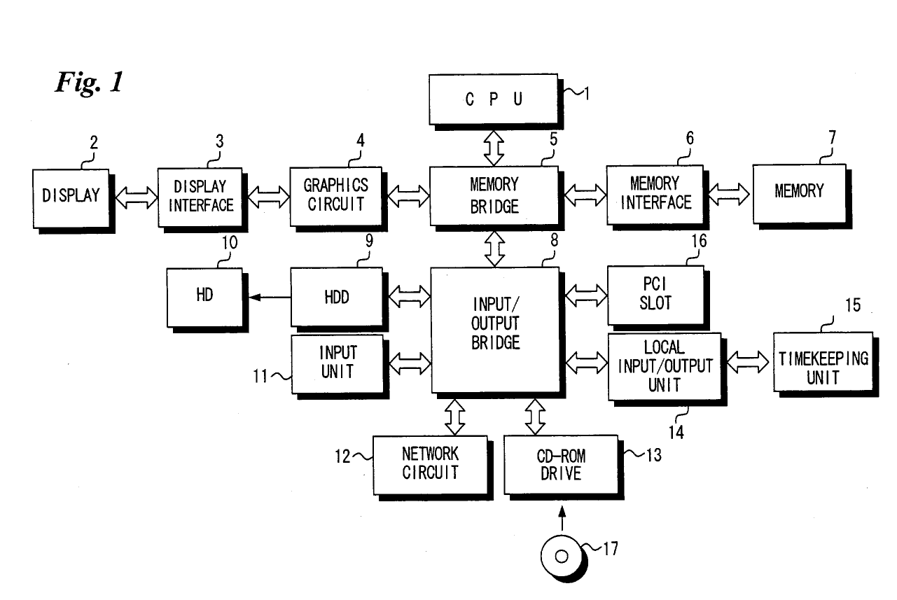

FIG. 1 is a block diagram illustrating the electrical configuration of a computer system according to a preferred embodiment of the present invention.

The overall operation of the computer system is controlled by a CPU 1.

A memory bridge 5 is connected to the CPU 1 by a system bus. A memory 7 is connected to the memory bridge 5 by an interface 6. A graphics circuit 4 is connected to the memory bridge 5, and a display unit 2 is connected to the graphics circuit 4 via a display interface 3.

An input/output (I/O) bridge 8 is connected to the memory bridge 5. A hard-disk drive 9, input unit 11, network circuit 12, CD-ROM (Compact Disk—Read-only Memory) drive 13, local input/output unit 14 and PCI (Peripheral Component Interconnect) slot 16 are connected to the input/output bridge 8. A timekeeping unit 15 for measuring time is connected to the local input/output unit 14. Image data (an image file) is written to a hard disk 10 and image data is read out of the hard disk 10 by the hard-disk drive 9. Image data, programs and the like that have been recorded on the CD-ROM 17 are read out by the CD-ROM drive 13. A program that has been stored on the CD-ROM 17 is read out by the CD-ROM drive 13 and installed in the computer, whereby an operation described below is carried out.

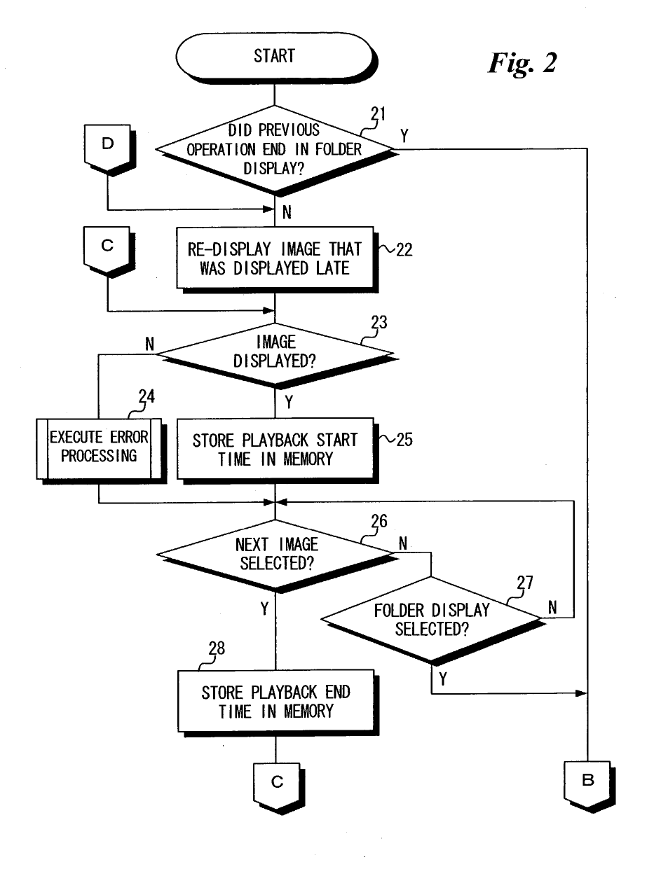

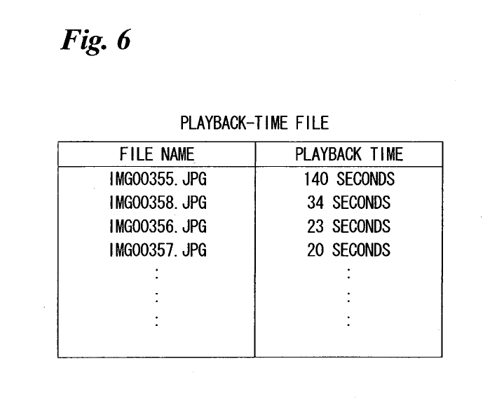

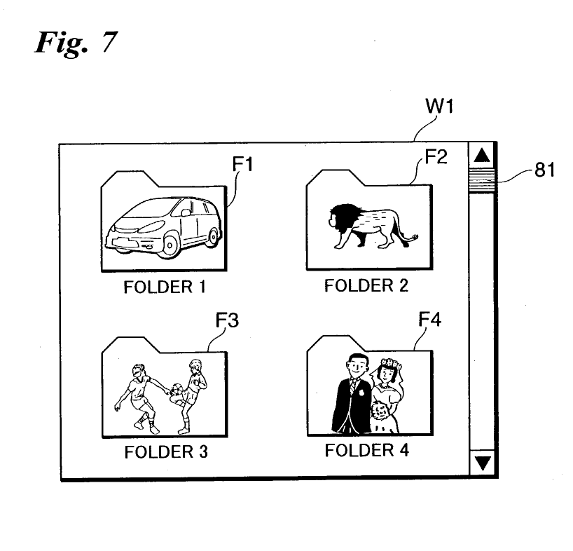

FIGS. 2 to 5 are flowcharts illustrating processing for generating images in the computer system, FIG. 6 illustrates the content of a playback-time file, and FIG. 7 illustrates an example of a window displayed on the display unit.

In this embodiment, a window can be displayed on the display screen of the display unit 2, and a folder icon that identifies image files that have been recorded on the hard disk 10 can be displayed in this window. This display of a folder shall be referred to as a “folder display”. As will be described later, the folder icon is generated using an image (representative image) having the longest playback time (display time) among a plurality of frames of images represented by image files contained in the folder identified by this folder icon.

The processing shown in FIGS. 2 to 5 starts in response to launching of folder display software. When the folder display software is launched, it is determined whether the previous operation of the folder display software ended with a folder display (step 21 in FIG. 2).

If operation did not end with a folder display (“NO” at step 21 in FIG. 2), as in a case where an image represented by an image file was being displayed, display processing is executed in such a manner that the last displayed image is displayed on the display screen of the display unit 2 again (step 22).

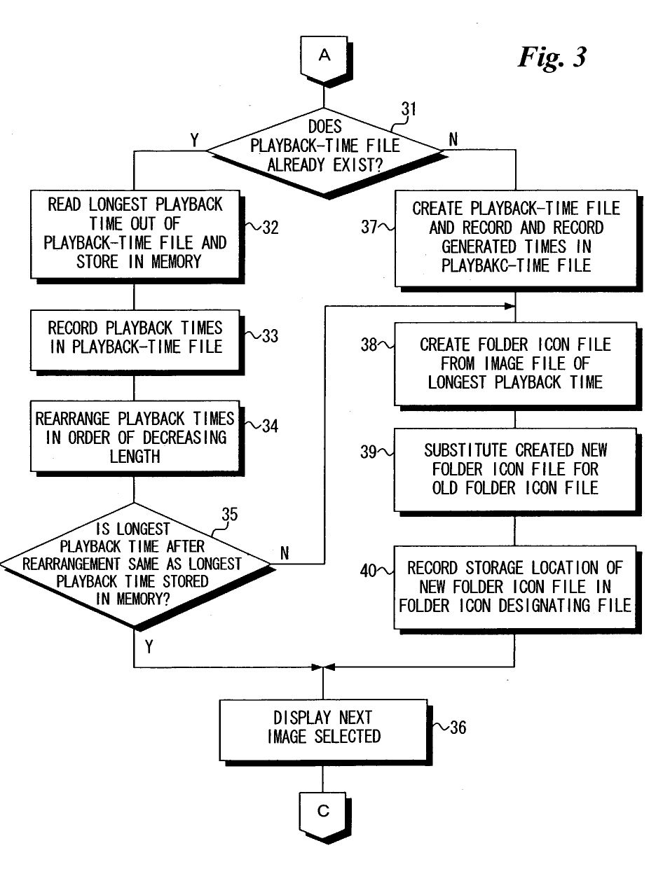

When this occurs, playback time (display time) of the image being displayed is measured as set forth below (steps 23 to 28 in FIG. 2 and steps 31 to 40 in FIG. 3).

First, whether the image has been displayed is checked (step 23 in FIG. 2). If the image has not been displayed (“NO” at step 23 in FIG. 2), then error processing is executed (step 24 in FIG. 2). If the image has been displayed (“YES” at step 23 in FIG. 2), then playback start time is read out of the timekeeping unit 15 and stored in the memory 7 (step 25 in FIG. 2).

If an image to be displayed next is selected by the user (“YES” at step 26 in FIG. 2), the image displayed until now vanishes from the display screen and, hence, the playback end time of this image is stored in the memory 7 (step 28 in FIG. 2).

Next, it is determined whether a playback-time file has already been created (step 31 in FIG. 3).

An example of content represented by a playback-time file is illustrated in FIG. 6. Data representing the playback times (total playback times) of images corresponding to image file names have been stored in a playback-time file in correspondence with the image file names. This playback-image file has been generated in association with a folder and has been stored in the corresponding folder. (Of course, the playback-time file need not necessarily be stored in the corresponding folder. The folder and the corresponding playback-time file may be linked.)

If a playback-time file corresponding to a folder containing image files representing images that have been played back already exists (“YES” at step 31), then data representing the longest playback time among the playback times is read out of this file and recorded in the memory 7 (step 32 in FIG. 3). Further, playback time obtained by subtracting playback start time from the playback end time stored in the memory 7 is calculated and added to the corresponding playback time in the playback-time file (step 33 in FIG. 3).

The playback times that have been recorded in the playback-time file are then rearranged in order of decreasing length (step 34 in FIG. 3).

If the longest playback time after rearrangement is the same as the longest playback time that has been stored in the memory 7 (“YES” at step 35 in FIG. 3), then this means that the image having the longest display time among the plurality of frames of images represented by the image files contained in the folder has not changed. The image utilized for the folder icon, therefore, does not change. The next image designated by the user is displayed on the display screen of the display unit 2 (step 36 in FIG. 3).

If the longest playback time after rearrangement is different from the longest playback time that has been stored in the memory 7 (“NO” at step 35 in FIG. 3), then the longest playback time changes to the playback time of the image that was being displayed. As a result, a folder icon file representing a folder icon that has the image represented by the image file having the changed longest playback time is created (step 38 in FIG. 3). This created new folder icon file is substituted for the old folder icon file (step 39 in FIG. 3). The storage location of the newly created folder icon file is recorded in a folder icon designating file that indicates the storage location of the folder icon file (step 40 in FIG. 3). Thus, a folder icon is created utilizing the image having the longest playback time.

If a playback-time file has not yet been created (“NO” at step 31 in FIG. 3), then a playback-time file is created and the playback times of the images that have been displayed are recorded (step 37). Subsequent processing is identical with that of steps 38 to 40 in FIG. 3 described above.

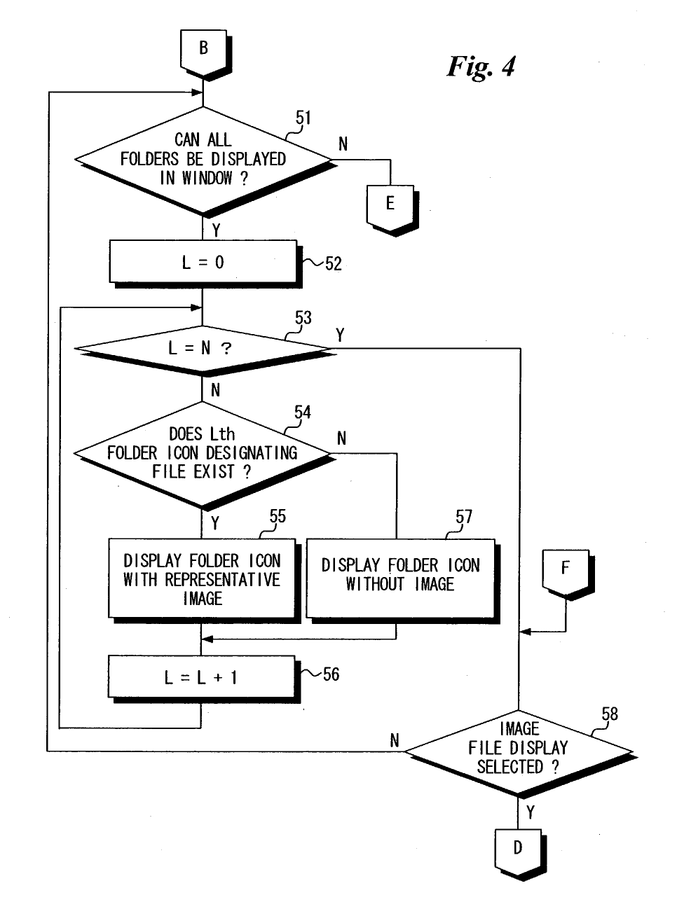

If, when an image is being displayed, a succeeding image is not selected (“NO” at step 26) but folder display is selected (“YES” at step 27 in FIG. 2), or if it is found that the previous operation ended with a folder display (“YES” at step 21), then processing illustrated in FIG. 4 is executed.

With reference now to FIG. 4, if all folders that have been stored on the hard disk 10 can be displayed in window W1 (naturally, it is permissible for some and not all of the folders stored on the hard disk 10 to be displayed) (“YES” at step 51 in FIG. 4), then processing for generating a folder icon is executed as indicated below.

First, a display variable L is reset (step 52 in FIG. 4). The display variable L is utilized in determining whether display of folder icons regarding all of the folders displayed in the window W1 has ended. If the display variable L agrees with a number N of list-display folders capable of being displayed in the window W1 (“YES” at step 53 in FIG. 4), then this means that display of folder icons capable of being displayed in the window W1 has ended.

If the display variable L does not agree with the number N of list-display folders capable of being displayed in the window W1 (“NO” at step 53 in FIG. 4), then it is determined whether the above-mentioned folder icon designating file exists with regard to an Lth folder (step 54 in FIG. 4). If the folder icon designating file exists (“YES” at step 54 in FIG. 4), then the folder icon represented by the folder icon file designated by this folder icon designating file (this folder icon is that generated using the image having the longest playback time in the manner described above, and it shall be referred to as a “folder icon with image”) is displayed in the window W1 (step 55 in FIG. 4). If a folder icon designating file does not exist (“NO” at step 54 in FIG. 4), then a folder icon without an accompanying image is displayed in the window W1 (step 57 in FIG. 4).

The display variable L is incremented (step 56 in FIG. 4) and the processing of steps 53 to 57 is repeated. If all folder icons are displayed in the window W1, the display variable L agrees with the number N of list-display folders (“YES” at step 53 in FIG. 4). Accordingly, if an image file display is selected (selection of display of an image represented by an image file in response to selection of the image file) and an image folder display is not selected (step 58 in FIG. 4), the folder display continues (“NO” at step 58). If an image folder display is not selected and an image file display is selected (“NO” at step 58 in FIG. 4), then image display and processing for calculating playback time of the image are performed as described above with reference to FIG. 2.

Thus, the window W1 shown in FIG. 7 is displayed on the display screen of the display unit 2. Generated folder icons F1 to F4 are displayed in the window W1. The represented images described above are used for the folder icons F1 to F4. A scroll bar 81 is provided on the right side of the window W1.

If all folder icons cannot be displayed in the window W1 (“NO” at step 51), scrolling is performed by moving the scroll bar 81 in window W1 so that folder icons not being displayed in the window W1 will appear in the window W1.

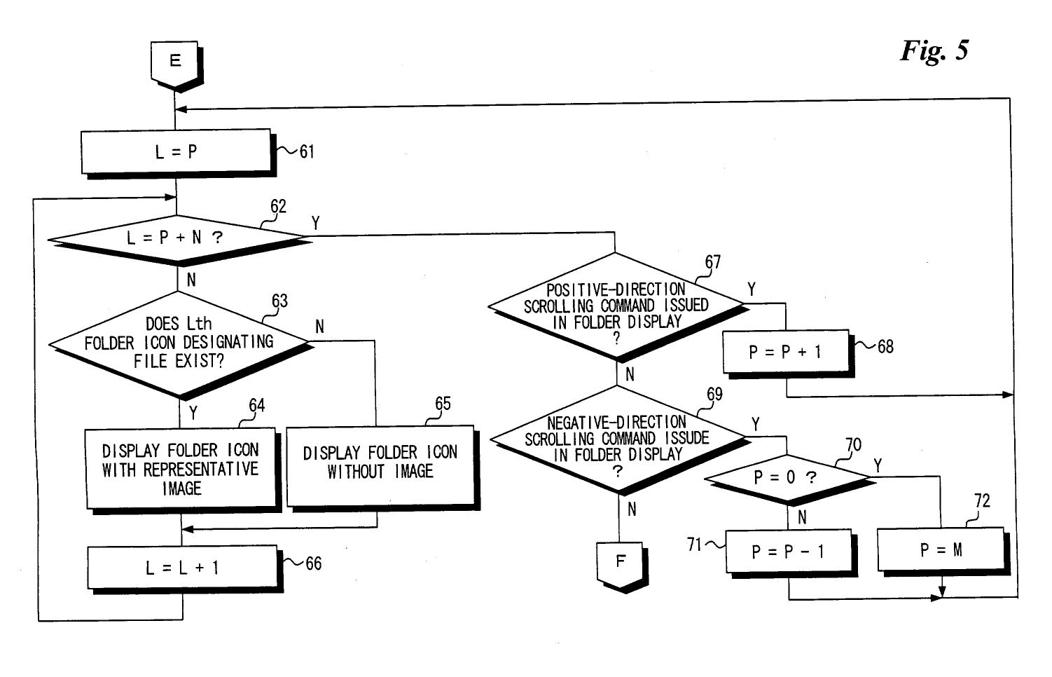

With reference now to FIG. 5, the display variable L is set to a display lead-off folder number P that starts from zero (step 61 in FIG. 5). The number P stipulates a folder icon displayed in the window W1. If the order of these folder numbers P is the order of the folder names and the folder names are numbers, then the order of the folder numbers P will be numerical order. If the folder names are alphabetic characters, then the order of the folder numbers P will be alphabetical order. If the folder names are in the Japanese language, then the order of the folder numbers P will be in the order of the kana syllabary.

It is determined whether the display variable L agrees with the sum of the display lead-off folder number P and the number N of list-display folders (step 62 in FIG. 5). If the display variable L agrees with the sum of the display lead-off folder number P and the number N of list-display folders, then this means that processing for displaying all folder icons capable of being displayed in the window W1 has ended.

If the display variable L does not agree with the sum of the display lead-off folder number P and the number N of list-display folders (“NO” at step 62 in FIG. 5), then processing identical with that of steps 54 to 57 in FIG. 4 is executed (steps 63 to 66 in FIG. 5). Thus, folder icons capable of being displayed in the window W1 are all displayed with or without representative images.

If the display variable L agrees with the sum of the display lead-off folder number P and the number N of list-display folders, then this means that processing for displaying all folder icons capable of being displayed in the window W1 has ended, as mentioned above. If the scroll bar 81 is moved in the positive direction (downward) in order to cause folder icons not being displayed in the window W1 to be displayed in the window W1 (“YES” at step 67 in FIG. 5), then the display lead-off folder number P is incremented (step 68 in FIG. 5). As a result, processing for causing the folder icon that follows the folder icon being displayed last in the window W1 to be displayed in the window W1 is executed (steps 63 to 66 in FIG. 5). Thus, the next folder icon is displayed in the window W1.

If the scroll bar 81 is moved in the negative direction (upward) in order to cause folder icons not being displayed in the window W1 to be displayed in the window W1 (“NO” at step 67 and “YES” at step 69 in FIG. 5), then it is determined whether the display lead-off folder number P is zero (step 70 in FIG. 5). If the display lead-off folder number P is not zero, the number P is decremented (step 71 in FIG. 5). As a result, processing for causing the folder icon that precedes the folder icon being displayed first in the window W1 to be displayed in the window W1 is executed (steps 63 to 66 in FIG. 5). Thus, the next folder icon is displayed in the window W1. If the display lead-off folder number P is zero (“YES” at step 70 in FIG. 5), no decrementing is performed and therefore the display lead-off folder number P is set to a total folder number M (step 72 in FIG. 5). When this occurs, the folder icon having the final folder name is displayed in the window W1 (steps 63 to 66 in FIG. 5).

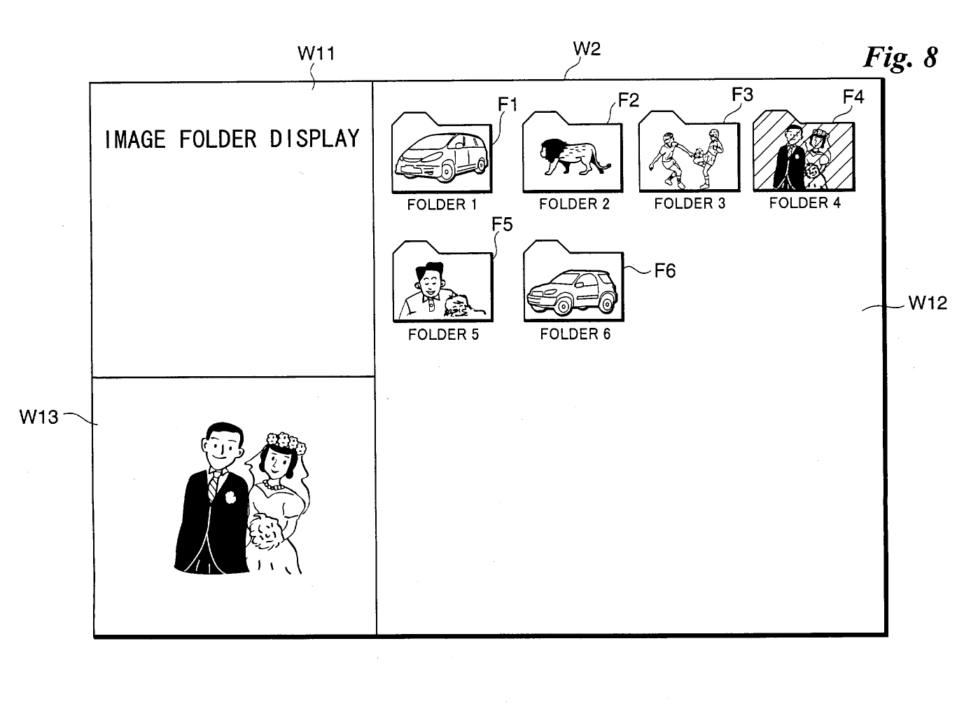

FIG. 8 illustrates an example of a window W2 displayed on the display screen of the display unit 2 according to a modification of the above embodiment.

The window W2 shown in FIG. 8 includes a small window W11 at the upper left, a small window W12 on the right side, and a small window W13 at the lower left. The small window W11 indicates that an image folder is being displayed, and the small window W12 presents a display of folder icons F1 to F6 arrayed in list form. The small window W13 displays an image that has been used in generating a folder icon selected by the user (folder icon F4 in FIG. 8 has been selected, and this fact is indicated by hatching) from among the folder icons being displayed in the small window W12. (The displayed image is a representative image of a plurality of frames of images represented by image files contained in the folder, as mentioned above.)

In general, folder icons are small and even though a representative image is displayed, therefore, it is difficult to see. Since a representative image that is large in comparison with the image of the folder icon is displayed in the small window W13, it is easy to check the representative image.

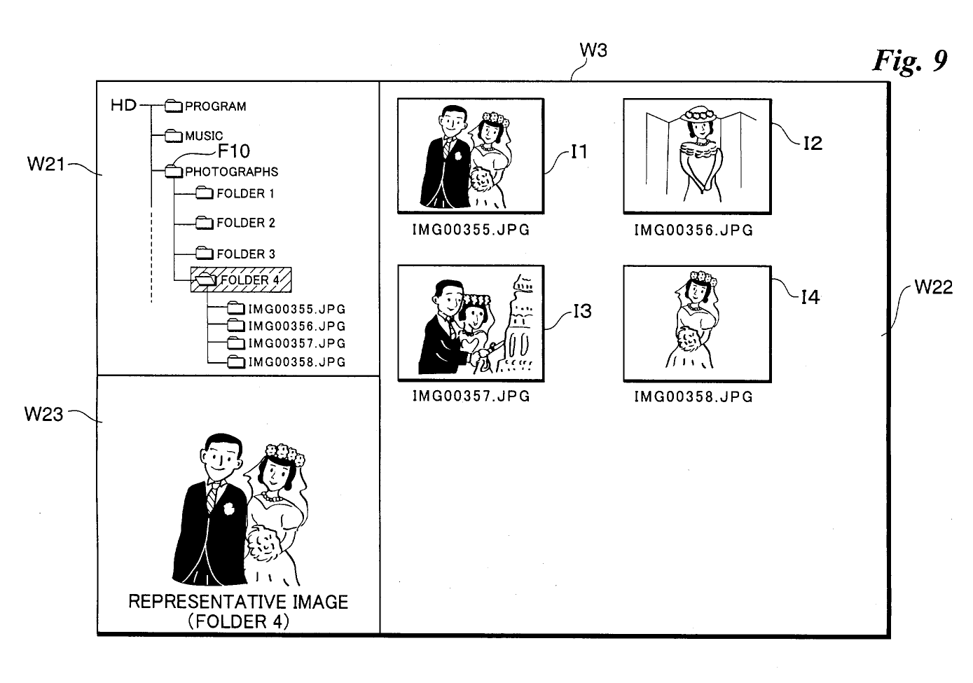

FIG. 9 illustrates an example of a window W3 displayed on the display screen of the display unit 2 according to another modification of the above embodiment.

The window W3 includes a small window W21 at the upper left, a small window W22 on the right side, and a small window W23 at the lower left.

A directory is displayed in the small window W21. A folder (Folder 4) selected by the user is indicated by hatching in this directory. Images (thumbnail images) represented by image files (image file names IMG00355.JPG to IMG00358.JPG) contained in the selected folder are displayed in the small window W22. A representative image of a plurality of frames of images represented by image files contained in the folder selected by the user is displayed in the small window W23. (If an image file representing only a single frame of an image is contained in the folder, then this image becomes the representative image.)

A comparatively large representative image is displayed in the case of FIG. 9 also. This makes it easier to check the image.

Though the foregoing embodiment has been described with regard to a computer system, the folder display according to this embodiment is not limited to a computer system and can be applied to any device or apparatus that displays images.

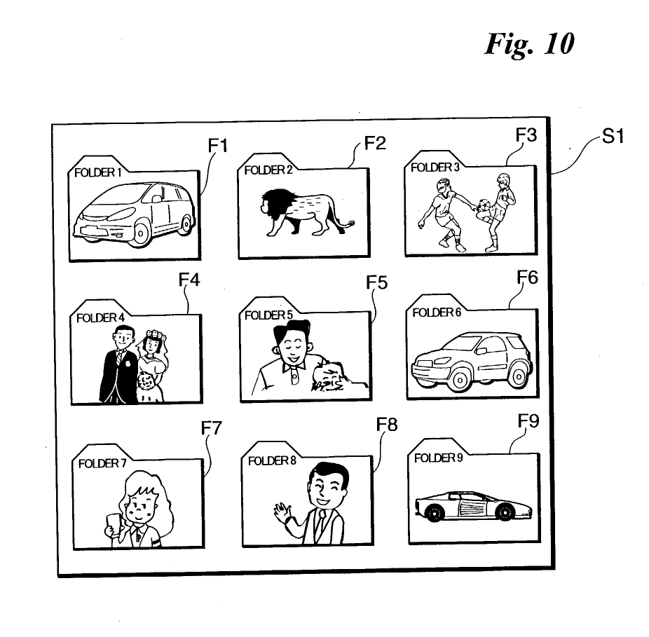

FIG. 10 illustrates an example of a display screen provided on the back of a digital still camera.

Folder icons F1 to F9 generated using representative images produced as described above are displayed in list form on a display screen S1. It will be understood that the folder icon display according to this embodiment is applicable even to a device such as a digital still camera. Further, it goes without saying that the electrical structure of a digital still camera includes circuits such as circuits for imaging and circuits for playback in addition to the electrical structure of a computer of the kind described above.

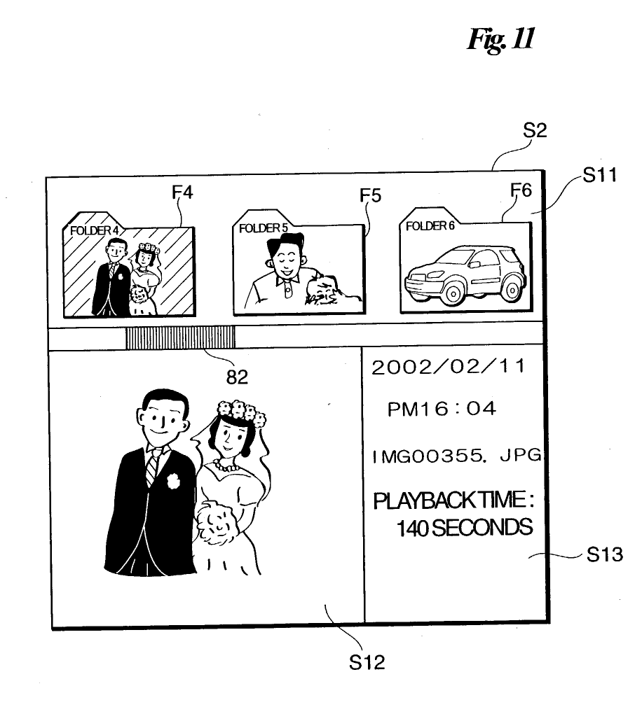

FIG. 11 illustrates an example of a display screen provided on the back of a digital still camera according to another modification.

Here a display screen S2 includes a folder icon display area S11 at the top, a representative image display area S12 at the lower left, and a representative image information display area S13 at the lower right.

The folder icon display area S11 displays, in list form, folder icons (folder icons F4 to F6, etc.) specifying folders that have been stored in the digital still camera. A folder icon (folder icon F4) selected by the user is indicated by hatching. The folder icon display area S11 also has a scroll bar 82. A folder icon that is not being displayed in the folder icon display area S11 is displayed by moving the scroll bar 82.

The representative image corresponding to the folder icon selected by the user is displayed in the representative image display area S12. Since a comparatively large representative image is displayed, the representative image can be verified even in a case where the display is presented on a comparatively small screen such as the display screen S2 on the back of the digital still camera.

Information (date and time of photography, file name and the above-described playback time) regarding the representative image being displayed in the representative image display area S12 is displayed in the representative image information display area S13. These items of image information have been recorded in the header area of the image file. Accordingly, playback time is recorded in the header area of the image file and not in the playback-time file as described above. This means that the above-described processing can continue to be executed even if a playback-time file is damaged.

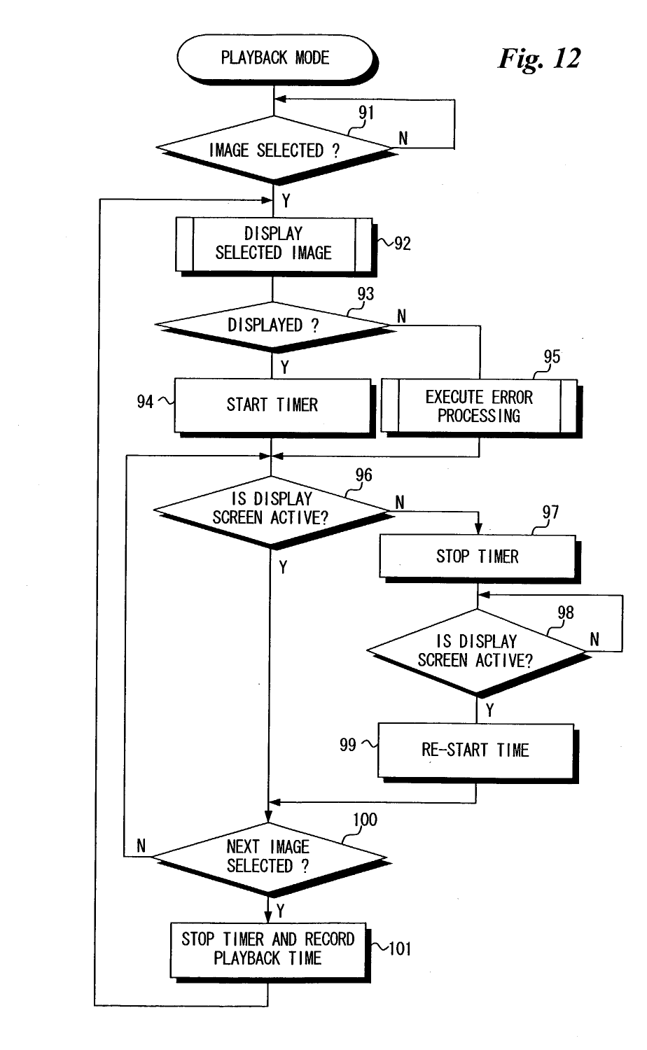

FIG. 12 is a flowchart illustrating processing for measuring playback time.

The display unit of a computer or the like can sustain image burn-in if the computer is not operated for a certain period of time. In order to prevent this, often a screensaver image is displayed on the display screen. In this processing, playback time of an image is measured in a state in which the display screen is active. (This is a state in which a window is displayed on the display screen and can be seen. That is, it is a state in which a screensaver is not being displayed, a state that is not a standby state, etc.) Essentially, the time the user has spent enjoying an image can be measured as the playback time.

A timer is used in this processing. The timer may be connected in place of the above-mentioned timekeeping unit 15 or may be added on anew. It goes without saying that the timekeeping unit 15 can be utilized in the manner described earlier.

If an image to be displayed on the display screen is selected (“YES” at step 91), then processing for displaying the selected image is executed (step 92). If the selected image is not displayed (“NO” at step 93), then error processing is executed. If the selected image is displayed (“YES” at step 93), the timer starts (step 94).

If the display screen of the display unit is active (“YES” at step 96), then the display of the selected image continues and so does measurement of time by the timer until the next image is selected (step 100). Measurement of time by the timer stops when the next image is selected. Data representing the obtained playback time thus is recorded in the above-described playback-time file in association with the image that was being displayed (step 101).

If the display screen of the display unit is not active (“NO” at step 96), this is a state in which the image cannot be viewed and, hence, the timer is stopped (step 97). When the display screen becomes active (“YES” at step 98), the timer starts again and measurement of playback time resumes (step 99).

In the above embodiment, a playback-time file is created and playback times represented by data that has been recorded in this playback-time file are sorted in order of decreasing length so that the longest playback time can be found. However, playback times need not necessarily be sorted in order of decreasing length. It may be so arranged that playback times are compared whenever a folder icon is created, thereby detecting the longest playback time. Further, if data representing playback time has not been recorded in the header area of an image file in the manner mentioned above, a playback-time file itself is not necessarily required.

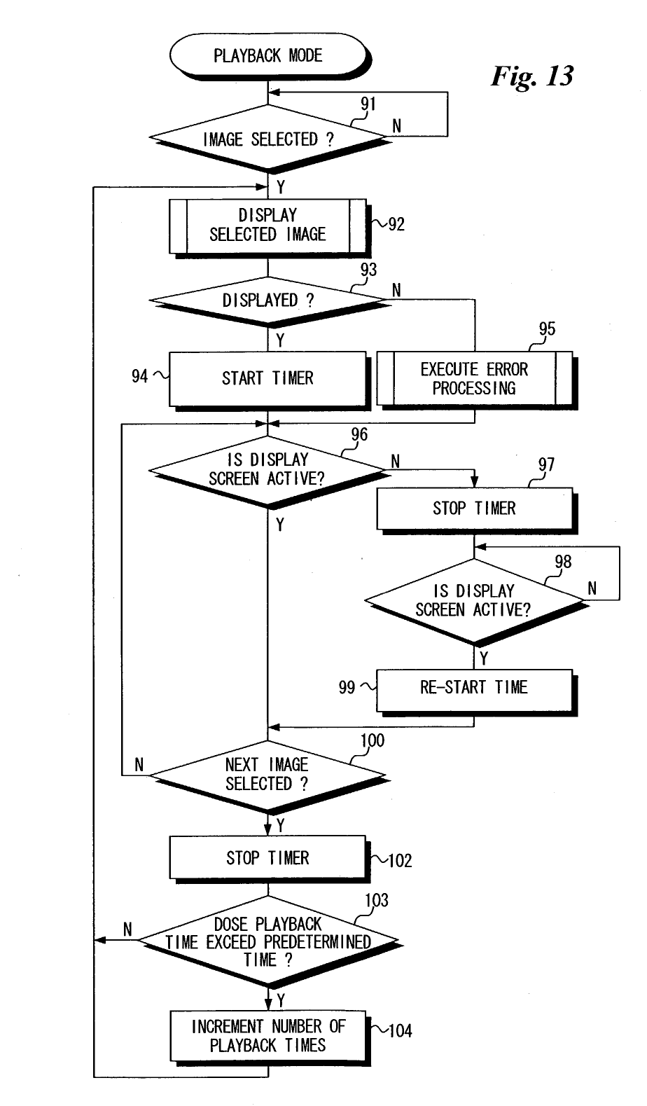

FIG. 13 is a flowchart illustrating processing for counting a number of times of playback (number of playback times), in which the same or like processing as that shown in FIG. 12 is indicated by the same reference numeral.

Although the playback time is measured and the image having the longest playback time becomes the representative image in the above embodiment, a number of playback times may be counted and the image having the largest number of playback times may become a representative image as described below.

If an image to be displayed is selected, the selected image is displayed (steps 91 and 92). When the image is displayed, the playback time is measured by a timer while the display screen is active (steps 91 to 102).

If the measured playback time exceeds a predetermined time (YES at step 103), the number of playback times of the image is incremented (step 104). The number of playback times is not incremented when the image is displayed just for confirmation, but the number of times of playback (display) of the image which was enjoyed for the predetermined time is counted.

A folder icon image is created using the image which has the large number of playback times by creating a number-of-playback-times file in the same way as the playback-time file. Of course the number of playback times may be incremented in response to the playback of the image, instead of incrementing the number of playback times when the playback time exceeds the predetermined time.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for generating a representative image, comprising:
a playback-time measurement device for measuring playback times of a plurality of frames of images represented by image files contained in a folder; and
a representative image data generating device for generating representative image data, which stands for the plurality of frames of images represented by the image files contained in the folder, based upon an image file that corresponds to the longest playback time among the playback times of the plurality of frames of images measured by said playback-time measurement device.

2. The apparatus according to claim 1, wherein the representative image data generated by said representative image data generating device is folder icon data representing a folder icon that identifies the folder.

3. The apparatus according to claim 1, wherein said playback-time measurement device measures playback time of an image in a case where the image is being displayed when a display device, which displays the representative image generated by said representative image data generating device, is in an active state.

4. An apparatus for generating a representative image, comprising:
a counting device for counting numbers-of-times of playback for a plurality of frames of images represented by image files contained in a folder; and
a representative image data generating device for generating representative image data, which stands for the plurality of frames of images represented by the image files contained in the folder, based upon an image file that corresponds to the largest-number-of times of playback among the numbers-of-times of playback of the plurality of frames of images counted by said counting device.

5. The apparatus according to claim 1 further comprising a playback-time measurement device for measuring playback time of the frame of the image represented by the image file contained in the folder, wherein
said counting device counts the number of times of playback by one when the playback time measured by said playback-time measurement device exceeds predetermined time.
